(19) United States
(12) Patent Application Publication
(10) Pub. No.: US 2018/0365268 A1
(43) Pub. Date: Dec. 20, 2018

(54) DATA STRUCTURE, SYSTEM AND METHOD FOR INTERACTIVE MEDIA

(71) Applicant: WindowLykr Inc., Los Angeles, CA (US)

(72) Inventor: Jacob Henderson, Los Angeles, CA (US)

(21) Appl. No.: 16/010,134

(22) Filed: Jun. 15, 2018

Related U.S. Application Data
(60) Provisional application No. 62/520,197, filed on Jun. 15, 2017.

(51) Int. Cl. G06F 17/30

(52) U.S. Cl. CPC G06F 17/30244; G06F 17/30864

(57) ABSTRACT

A plurality of records is for use with: a plurality of images and a device. The images are in digital form. The device is of the type that (i) has a display; (ii) has an operating system having a plurality of functions; and (iii) allows a viewer of the display to select a point on the display in use. The records comprise, for each of the images, an associated record, at least one of the associated records including: data indicative of a boundary associated with an object that appears in the image for which the record is provided; and data indicative of one of the plurality of functions.

### CROSS-REFERENCE TO RELATED APPLICATION

This application claims the benefit of U.S. Provisional Patent Application Ser. No. 62/520,197, filed Jun. 15, 2017 and entitled DATA STRUCTURE, SYSTEM AND METHOD FOR INTERACTIVE MEDIA.

### BACKGROUND OF THE INVENTION

### 1 Field of the Invention

The invention relates to the field of interactive media.

### 2. Prior Art

It is known to provide interactivity in media, for example, to allow a person viewing a movie on a touch screen device to trigger a presentation or the like by touching a portion of the screen. However, interactive media is not yet ubiquitous, notwithstanding the benefits known to be available therefrom. Possible explanations include, inter alia, technical complexity, processing limitations and bandwidth limitations.

### SUMMARY OF THE INVENTION

Forming one aspect of the invention is plurality of records for use with
a plurality of images, the images being in digital form; and
a device, the device being of the type that (i) has a display; (ii) has an operating system having a plurality of functions; and (iii) allows a viewer of the display to select a point on the display in use.

The plurality of records comprises: for each of the images, an associated record, at least one of the associated records including:
data indicative of a boundary associated with an object that appears in the image for which the record is provided; and
data indicative of one of the plurality of functions.

The plurality of records can be combined with the plurality of images for which they are provided to a combination which forms another aspect of the invention.

Forming another aspect of the invention is a system for use with the combination and a device, the device being of the type that: (i) has a display; (ii) has an operating system having a plurality of functions; and (iii) allows a viewer of the display to select a point on the display in use.

The system comprises:
an event handler computing functionality adapted, responsive to the selection of a point on the display when one of the images is displayed thereon, to transmit data indicative of the selected point and image; and
an analysis computing functionality adapted to
   receive the data indicative of the selected point and image from the event handler computing functionality; and
   transmit to the device, in respect of any boundary in the record which encompasses the selected point, the function associated with that boundary.

According to yet another aspect of the invention, the device for which the system is for use can be selected from the group consisting of phone, tablet computer and tabletop computer.

Advantages, features and characteristics of the invention will be apparent upon a review of the detailed description and the appended drawings, the latter being briefly described hereinafter.

### BRIEF DESCRIPTION OF THE DRAWINGS

FIG. 1 shows, in schematic form, a system according to an exemplary embodiment of the invention in its environment;

FIG. 2 shows the progression of an image (top frame) to an Objects of Interest matte (second frame) to a color coded object map (third frame) to vector data (bottom frame), all as carried out in the exemplary embodiment;

FIG. 3 is a screen shot of an exemplary developer tool;

FIG. 4 is a screen shot of an exemplary developer tool;

FIG. 5 is a screen shot of an exemplary developer tool;

FIG. 6 is a screen shot of an exemplary developer tool;

FIG. 7 is a screen shot of an exemplary developer tool; and

FIG. 8 is a screen shot of an exemplary developer tool.

### DETAILED DESCRIPTION OF THE PREFERRED EMBODIMENTS

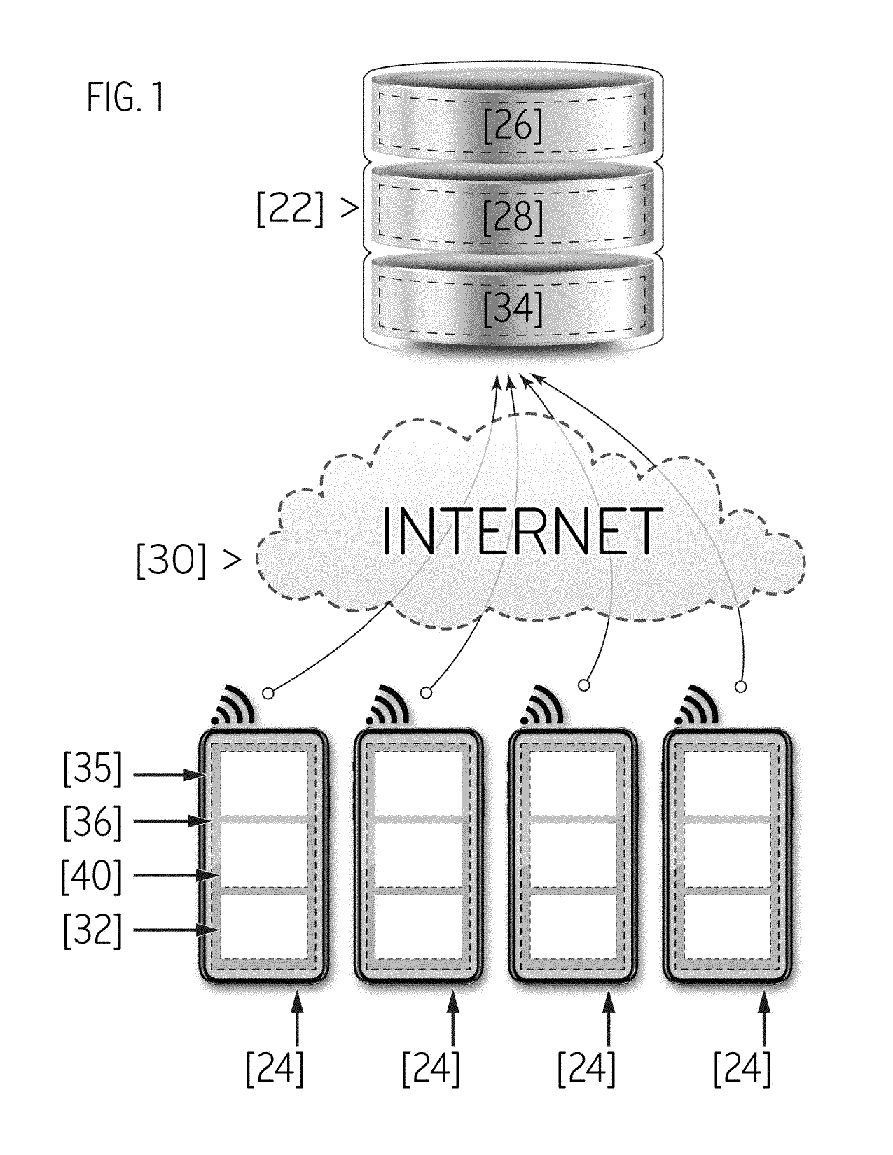

A system 20 which forms an exemplary embodiment of the invention is shown schematically in FIG. 1 in combination with a server 22, a plurality of tablet computers 24, a plurality of video files [shown notionally by broken line 26], a plurality of records [shown notionally by broken line 28] and the Internet 30, and will be seen to comprise a plurality of event handler computing functionalities, each shown notionally by broken line 32 and an analysis computing functionality shown notionally by broken line 34.

The server 22 will be understood to be a conventional server connected to the Internet 30.

The tablet computers 24 will be understood to be of the type that:
connect to the Internet 30;
have a display 35 with touch screen functionality thereby to allow a viewer of the display 35 to select a point on the display in use; and
have an operating system 36 having a graphics library 38 and a browser 40, the graphics library having the functions flash, haptic shake and auditor tone, all being shown notionally by broken lines

The video files 26 each comprise a plurality of images in digital form loaded on the server and can: include one or more of photographic imagery, graphics, photorealistic rendering and text; and/or define a moving picture. The files 26 can be transmitted from the server 22 to the tablets 24 in a conventional fashion for viewing thereon.

The plurality of records 28 is embodied in the form of a .net database on the server and comprise, for each of the images, an associated record, at least one of the associated records including: (i) data indicative of a boundary associated with an object that appears in the image for which the record is provided, the data being expressed in vector form; and (ii) data indicative of one of the plurality of functions.

The event handler computing functionalities 32 are provided and associated one for each of the tablets 24, each event handler computing functionality being defined by computer executable instructions contained within the operating system of the same device for which such functionality is provided and adapted:
responsive to the selection of a point on the display when one of the images is displayed thereon, to transmit data indicative of the selected point and image to the server, specifically, a time stamp and an X-Y coordinate; and
when a function is transmitted to the device, activate the function.

The analysis computing functionality 34 is defined by computer executable instructions stored on the server 22 and is adapted to receive the data indicative of the selected point and image from the event handler computing functionality and transmit to the device, in respect of any boundary in the record which encompasses the selected point, the function associated with that boundary. [For greater certainty in this regard, it will be understood that not all objects in a video stream will be functionalized and the functionality available in respect of any object may change over time, such that not all transmissions to the server will result in a function transmitted to the device.]

Persons of ordinary skill will readily appreciate that the system provides significant advantage in use in terms of processing and bandwidth requirements. By leveraging server technology, the native functionality of the portable devices, video can be provided with significant interactivity with relatively low incremental bandwidth requirements. [No real time data associated with the interactivity is transmitted unless and until a response is triggered, and even then, the data packs, being defined merely by, in one direction, an positional co-ordinate and a time stamp, and in the other direction, by the name of a function, are minimal].

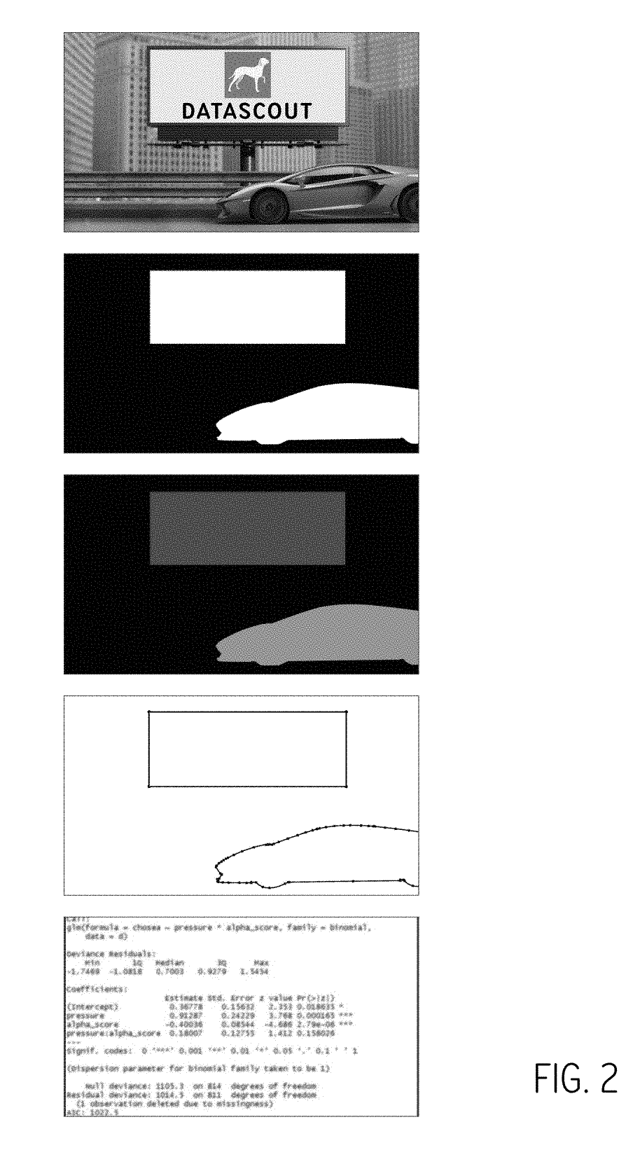

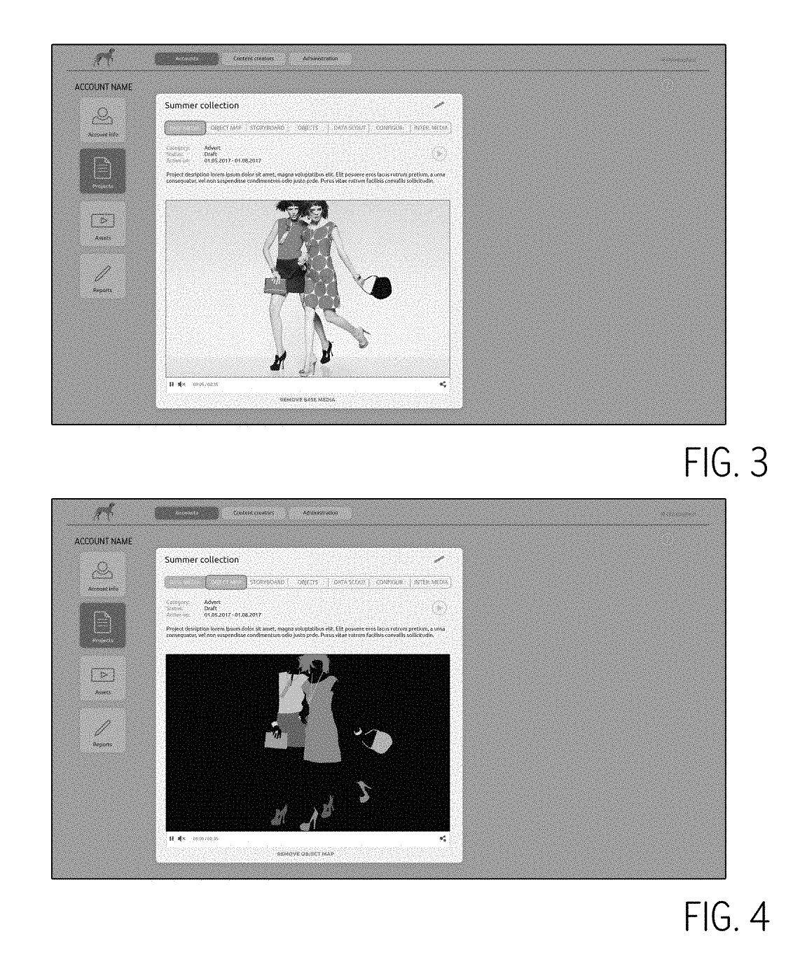

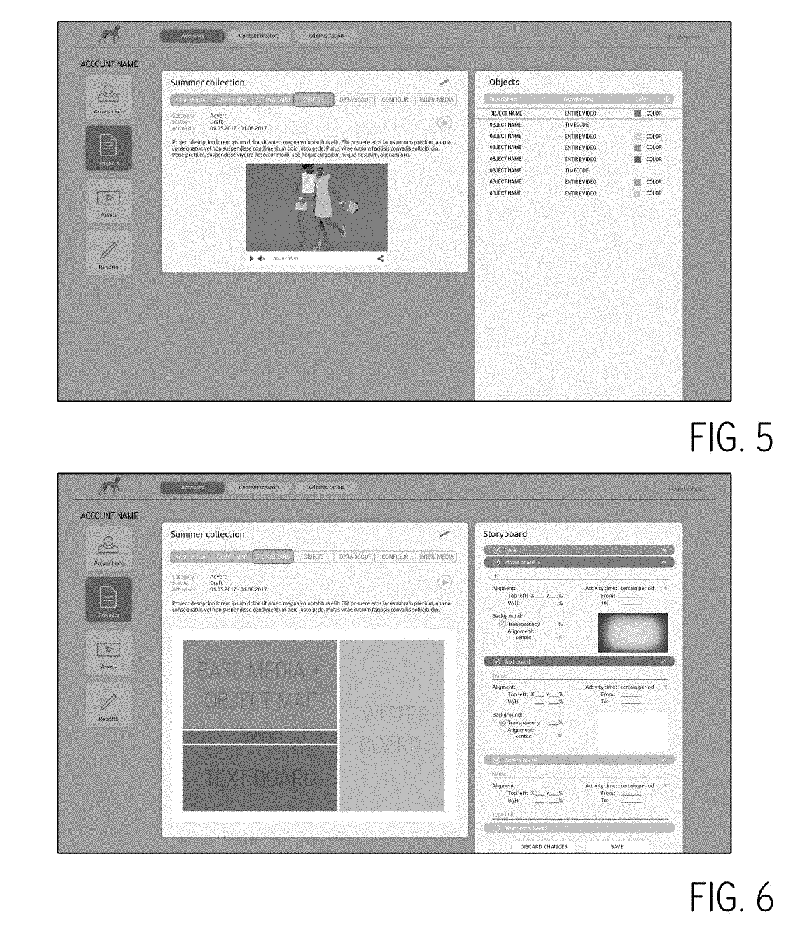

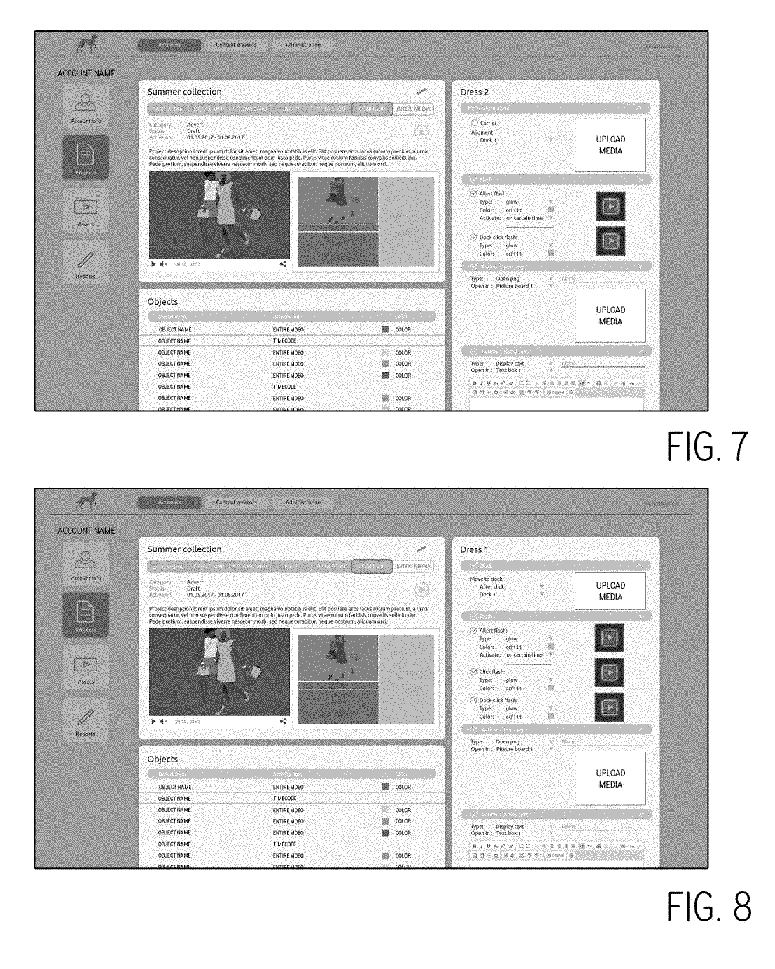

Constructing and utilizing the system described herein will be a matter of routine to persons of ordinary skill in the art, and accordingly, details of the coding structure is neither required nor provided, but one useful manifestation of the foregoing has been found to include as salient aspects:
The use of conventional edge detection and regression tools to produce a vector-based map of objects of interest in the images.
   FIG. 2 shows the progression of an image (top frame) to an Objects of Interest matte (second frame) to a color coded object map (third frame) to vector data (bottom frame).
Providing a developer tool, to enable persons with limited programming knowledge to functionalize videos.
   FIGS. 3-8 show screen shots of an exemplary developer tool. FIG. 3 is notable for its inclusion of an exemplary photographic image with which the system can be used. FIG. 4 shows the color coded object map of the objects functionalized in such image. FIG. 5 is notable for its inclusion of a chart that shows the some of the objects are functionalized over the entire length of the video, and others are functionalized only over specific timecodes. FIGS. 7 and 8 are illuminative into the manner in which objects can be functionalized differently in that in FIG. 7, the object entitled Dress 1 has three flash functions associated therewith, whereas in FIG. 8, Dress 2 has only two flash functions.
A menu of functions selected for availability in all supported devices and, on each supported device, an index, allowing the device to understand a common lexicon for actuation of functions.

Whereas a specific embodiment is herein shown and described variations are possible.

For example, whereas a time stamp and X-Y coordinate are indicated to be transmitted, this is not strictly necessary. For example, the system could be embodied in holographic form, in which case, an X,Y,Z coordinate could be transmitted. Similarly, whereas a time stamp is transmitted, an alternative would be to provide each image in the series a unique identifier, in which case, the identifier could be transmitted.

Further, whereas the image files are indicated to be loaded on the server and transmitted to the devices, this is not required. The images could be pulled from anywhere and downloaded on the devices prior to viewing or in real time.

As well, whereas various portable touch screen devices are specifically mentioned, the system could be embodied in various combinations using projectors, pointers and sensors. Moreover, whereas three very specific graphics functions are mentioned, it will be evident that these three (haptic shake, flash and auditory tone) were mentioned only for context and are not intended to be limiting in any way. Selection of an object in a video could, in addition to animating the object [to indicate that the selection has been made] trigger, for example, only:
an immediate textual presentation including details of the object such as purchase price and availability
population of a virtual basket of items, for subsequent analysis and potential purchase
a social media “like”

Yet further, whereas the described analysis functionality is server based, this could be embodied on the devices themselves, to permit offline viewing.

Moreover, whereas .net functionality is mentioned, other platforms can be used.

Additionally, whereas functionality requires only minimal data packs to be transmitted to the server, more information can and will likely be transmitted. For example, to the extent that the viewer of the video interacts with social media during the screening, details of such interactions may be transmitted to the server and collected. Similarly, the system could be embodied to transmit different types of selections to the server, such as “double clicks”, thereby to enable differing types of functions to be activated.

It should also be appreciated that although the description contemplates a record for each image, this is not necessarily required. For example, in moving pictures, a minimum speed of 30 frames per second is typical, to avoid choppiness; this speed is far greater than speed at which the average human could be expected to interact. Accordingly, it could be found useful to reduce the number of records to less than 1:1.

Finally, but without limitation, it should be appreciated that the invention is susceptible to varied embodiments. An exemplary embodiment is illustrated in the video sequence of Appendix A and the accompanying script of Appendix B.

Accordingly, the invention should be understood to be limited only by the accompanying claims, purposively construed.

What is claimed is:

1. A plurality of records for use with
a plurality of images, the images being in digital form; and
a device, the device being of the type that (i) has a display; (ii) has an operating system having a plurality of functions; and (iii) allows a viewer of the display to select a point on the display in use,
the plurality of records comprising, for each of the images, an associated record, at least one of the associated records including: data indicative of a boundary associated with an object that appears in the image for which the record is provided; and data indicative of one of the plurality of functions.

2. A plurality of records according to claim 1, wherein the functions are defined at least in part by a graphics library that forms part of an operating system.

3. A plurality of records according to claim 1, wherein the functions comprise flash, shake and tone.

4. A plurality of records according to claim 1, embodied in the form of a .net database.

5. A plurality of records according to claim 1, wherein the functions are defined at least in part by a browser that forms part of an operating system.

6. A plurality of records according to claim 1, wherein the data indicative of a boundary is expressed in vector form.

7. In combination: (i) a plurality of images in digital form; and (ii) a plurality of records for use with such images according to claim 1.

8. The combination of claim 7, wherein the images include one or more of photographic imagery, graphics, photorealistic rendering and text.

9. The combination of claim 7, wherein the images define a moving picture.

10. A system for use with
the combination of claim 7; and
a device, the device being of the type that (i) has a display; (ii) has an operating system having a plurality of functions; and (iii) allows a viewer of the display to select a point on the display in use,
the system comprising:
an event handler computing functionality adapted, responsive to the selection of a point on the display when one of the images is displayed thereon, to transmit data indicative of the selected point and image; and
an analysis computing functionality adapted to: receive the data indicative of the selected point and image from the event handler computing functionality; and transmit to the device, in respect of any boundary in the record which encompasses the selected point, the function associated with that boundary.

11. The system of claim 10, wherein: the event handler computing functionality is defined by computer executable instructions stored on the device; the analysis computing functionality and the records are remote from the device; and the event handler computing functionality is adapted to, when the function is transmitted to the device, activate the function.

12. The system of claim 10, wherein the data indicative of the selected point is X,Y data and the data indicative of the selected image is a time stamp.

13. A system for use with
the combination of claim 7; and
a device, the device being selected from the group consisting of phone, tablet computer and tabletop computer and being of the type that (i) has a display; (ii) has an operating system having a plurality of functions; and (iii) allows a viewer of the display to select a point on the display in use,
the system comprising:
an event handler computing functionality adapted, responsive to the selection of a point on the display when one of the images is displayed thereon, to transmit data indicative of the selected point and image; and
an analysis computing functionality adapted to: receive the data indicative of the selected point and image from the event handler computing functionality; and transmit to the device, in respect of any boundary in the record which encompasses the selected point, the function associated with that boundary.
